(19) United States
(12) Patent Application Publication
(10) Pub. No.: US 2014/0233562 A1
(43) Pub. Date: Aug. 21, 2014

(54) SYSTEM AND METHOD FOR POINT-TO-MULTIPOINT COMMUNICATION

(71) Applicant: INANGO SYSTEMS LTD., Tzofit (IL)

(72) Inventors: Boris SHEHTER, Kfar Saba (IL); Jonathan MASEL, Tzofit (IL)

(73) Assignee: INANGO SYSTEMS LTD., Tzofit (IL)

(21) Appl. No.: 13/773,226

(22) Filed: Feb. 21, 2013

(51) Int. Cl. H04L 12/56

(52) U.S. Cl. CPC H04L 45/16
USPC 370/390

(57) ABSTRACT

A communication system including: a P2MP root device, configured to communicate with multiple P2MP user-end devices over a shared network accessible to each of the P2MP user-end devices; and multiple adaptors, each being connected between a first pan and a second part of a respective Pt2Pt communication line, and also connected to the P2MP root communication device by a respective P2MP communication line. Each of the adaptors is configured to: transfer Pt2Pt electric signals of Pt2Pt communication between the first and the second parts of the respective Pt2Pt communication line; transfer P2MP electric signals of P2MP communication between the second part of the respective Pt2Pt communication line and the respective P2MP communication line; and passively convert between the P2MP electric signals which are transferred over the respective P2MP communication line and the P2MP electric signals of the P2MP communication transferred over the second part of the respective Pt2Pt communication line.

### FIELD OF THE INVENTION

This invention relates to point-to-multipoint communication systems and methods.

### BACKGROUND OF THE INVENTION

FIG. 1 is a block diagram illustrating a topology of a prior art point-to-point communication system 10. For example, point-to-point communication system 10 may be a telephony system, wherein each of the user-end devices 12 is the landline telephone of each respective user.

In point-to-point communication system 10, each of a plurality of user-end devices 12 (denoted “Pt2Pt communication device”, wherein Pt2Pt stands for “point-to-point”) is connected to a different remote end communication unit 14 by a different connection. The connection between each of the plurality of the user-end devices 12 to the respective remote end communication unit 14 is a separate wired connection 16. Such a wired connection 16 may be for example a line (e.g. a twisted pair line, a telephony cable, etc.).

The communication transmitted along each of the wired connections 16 is transmitted irrespective of the communication in any one or the other wired connections 16 (if neglecting undesired effects such as electromagnetic interference between such wired connections 16). It should be noted that while multiple remote end communication units 14 may be implemented in a single device (e.g. a telephone exchange), that device would have different physical interface and PHY level connection to each of the respective wired connections 16, and it would furthermore communicate independently with each of the different user-end devices 12 so that the user-end devices 12 would not be exposed to the communication of any one of the other user-end devices 12.

FIG. 2 is a block diagram illustrating a topology of a prior art point-to-multipoint communication system 20. For example, point-to-multipoint communication system 20 may be a cable television distribution system, wherein each of the user-end devices 22 is the set-top-box (STB) of each respective user.

in point-to-multipoint communication system 20, all of the multiple user-end devices 22 (denoted “P2MP communication device”, wherein P2MP stands for “point-to-multipoint”) are connected to a single root device 24 over a shared medium in a tree-like topology. The tree-like network can be implemented using one or more types of wired connections 26. Such wired connections 26 may be for example a cable (e.g. a coax line, a power line, etc).

The communication transmitted in the treelike network is exposed to any one of the user-end devices 22. Different mechanisms may be implemented to distinguish communication between the root device 24 and each of the user-end devices 22. But a few examples are time-division multiplexing, frequency-division multiplexing, code-division multiplexing, addressed packets, and the like.

The root device 24 would have a single physical interface and a single PHY level is connection to connect itself to the entire treelike network. It is however noted that in some implementations, a single P2MP root device 24 may have more than one physical interface and one PHY level connection for connecting it to multiple treelike networks. However, each of those networks would be independent of the other networks, and would behave like the treelike network discussed above.

Implementation of such a P2MP network may be achieved, for example, by using one or more P2MP splitters 28, each of which has multiple connections that enable to connect multiple devices (e.g. root device 24, one or more P2MP communication devices, other one or more splitters 28). Such splitters 28 may be combined with other network components (such as amplifiers, filters, noise reducers, etc.), but this is not necessarily so. In this context it is noted that in each of the networks (of system 10 and of system 20) other such network components (such as amplifiers, filters, noise reducers, etc.) may be implemented, even though not illustrated. It is further noted that at least some of the splitters 28 may be implemented as smarter nodes that are aware of content transmitted in the communication passing through which, and respond based on that content.

There is a need in the art for new point-to-point communication systems and for new methods of point-to-point communication.

### SUMMARY OF THE INVENTION

According to an aspect of the invention, a communication system is disclosed, the communication system including: (a) a point-to-multipoint (P2MP) root device, configured to communicate with multiple P2MP user-end devices over a shared network accessible to each of the P2MP user-end devices; and (b) multiple adaptors, each of which is connected between a first part and a second part of a respective point to point (Pt2Pt) communication line, and also connected to the P2MP root communication device by a respective P2MP communication line; wherein each of the adaptors is configured to: transfer Pt2Pt electric signals of Pt2Pt communication between the first and the second parts of the respective Pt2Pt communication line; (ii) transfer P2MP electric signals of P2MP communication between the second part of the respective Pt2Pt communication line and the respective P2MP communication line; and (iii) passively convert between the P2MP electric signals which are transferred over the respective P2MP communication line and the P2MP electric signals of the P2MP communication transferred over the second part of the respective Pt2Pt communication line.

Optionally, each of the multiple adaptors is configured to passively convert the P2MP electric signals using a physical layer conversion, thereby transmitting the same media access control (MAC) layer data between the respective P2MP communication line and the second part of the respective Pt2Pt communication line over different physical layers.

Optionally, at least one of the adaptors includes an electric interface to which preexisting operational Pt2Pt communication infrastructure which includes the respective Pt2Pt communication line is connected.

Optionally, at least one of the adaptors is further configured to block transmission of P2MP communication to the first part of the respective Pt2Pt communication line.

Optionally, at least one of the adaptors is further configured to block transmission of Pt2Pt communication to the P2MP root device.

Optionally, the communication system further includes the multiple P2MP user-end devices and the Pt2Pt communication lines connecting each of the adaptors to a different P2MP user-end device.

Optionally, all of the P2MP communication transmitted in the shared network, which includes the second parts of all of the Pt2Pt communication lines, is transmitted to each of the P2MP user-end devices.

Optionally, at least one of the adaptors is configured to concurrently transfer P2MP communication and Pt2Pt communication over the respective second part of the Pt2Pt communication line, wherein the P2MP communication is transferred to the respective P2MP user-end device, and the Pt2Pt communication is transmitted to a respective Pt2Pt user-end communication device that is separate from the respective P2MP user-end device.

Optionally, a ratio between (a) a length of any P2MP communication line connecting the P2MP root device 224 and (b) a respective adaptor to a length of the second part of the respective Pt2Pt communication line that connects the adaptor to the respective P2MP user-end device is smaller than 1:50.

Optionally, at least one of the P2MP user-end devices is an intermediary device configured to transmit over at least a part of another P2MP network P2MP communication received from the P2MP root device, wherein P2MP communication of a different P2MP root device is transmitted in the other P2MP network.

Optionally, including at least one filter that prevents transmission of P2MP communication transmitted by the intermediary device to a part of the other P2MP network.

According to an aspect of the invention, a communication system is disclosed, which includes: (a) a point-to-multipoint (P2MP) root device, configured to communicate with multiple P2MP user-end devices over a shared network accessible to each of the P2MP user-end devices; (b) an adaptor connected between a first part and a second part of a Pt2Pt communication line, and also connected to the P2MP root communication device by a respective P2MP communication line; the adaptor is configured to: transfer Pt2Pt electric signals of Pt2Pt communication between the first and the second parts of the respective Pt2Pt communication line; and transfer P2MP electric signals of P2MP communication between the second part of the respective Pt2Pt communication line and the respective P2MP communication line; and to passively convert between the P2MP electric signals which are transferred over the respective P2MP communication line and the P2MP electric signals of the P2MP communication transferred over the second part of the respective Pt2Pt communication line; and (c) an intermediary device configured to transmit P2MP communication received from the P2MP root device over at least a part of another P2MP network in which P2MP communication of a different P2MP root device is transmitted.

Optionally, the adaptor is configured to passively convert the P2MP electric signals using a physical layer conversion, thereby transmitting the same media access control (MAC) layer data between the respective P2MP communication line and the second part of the respective Pt2Pt communication line over different physical layers.

According to an embodiment of the invention, a method for communication is disclosed, the method including: (a) transmitting by a point-to-multipoint (P2MP) root device P2MP communication to multiple P2MP user-end devices over a shared network accessible to each of the P2MP user-end devices; (b) transferring, by an adaptor that is connected is between a first part and a second part of a Pt2Pt communication line and also connected to the P2MP root communication device by a respective P2MP communication line, Pt2Pt electric signals of Pt2Pt communication between the first and the second parts of the Pt2Pt communication line; and (c) transferring by the adaptor P2MP electric signals of P2MP communication between the respective P2MP communication line and the second part of the Pt2Pt communication line, the transferring of the P2MP electric signals including passively converting between the P2MP electric signals which are transferred over the respective P2MP communication line and the P2MP electric signals of the P2MP communication transferred over the second part of the respective Pt2Pt communication line.

Optionally, the passive converting of the P2MP electric signals includes passively converting the P2MP electric signals using a physical layer conversion, thereby transmitting the same media access control (MAC) layer data. between the respective P2MP communication line and the second part of the respective Pt2Pt communication line over different physical layers.

Optionally, the method further includes: for at least one other adaptor which is connected to the P2MP root device by a respective other P2MP communication line and between a first part and a second part of a respective other Pt2Pt communication line, transferring by the other adaptor Pt2Pt electric signals of Pt2Pt communication between the first and the second parts of the respective other Pt2Pt communication line; and transferring by the other adaptor P2MP electric signals of P2MP communication between the respective other P2MP communication line and the second part of the respective other Pt2Pt communication line; wherein the transferring of the P2MP electric signals by the other adaptor includes passively converting between the P2MP electric signals which are transferred over the respective other P2MP communication line and the P2MP electric signals of the P2MP communication transferred over the second part of the respective other Pt2Pt communication line.

According to an embodiment of the invention, a method for utilizing preexisting operational Pt2Pt communication infrastructure for P2MP communication, the method including: (a) for each out of multiple Pt2Pt communication lines of the preexisting operational Pt2Pt communication infrastructure, connecting to the respective Pt2Pt communication line an adaptor; (h) providing a P2MP root device and connecting the P2MP root device to all of the adaptors, the connecting including connecting the P2MP root device to each of the adaptors by a P2MP communication line; and (c) communicating over the preexisting operational Pt2Pt communication infrastructure Pt2Pt communication and P2MP communication, according to the aforementioned method for communication.

Optionally, the connecting of the adaptors is preceded by locating the preexisting operational Pt2Pt communication infrastructure which does not include any P2MP infrastructure and which is not connected to any P2MP communication device.

Optionally, the connecting of each of the adaptors includes connecting the respective Pt2Pt communication line to an electric interface of the respective adaptor, wherein the transferring of the P2MP electric signals by the adaptor includes transferring the P2MP electric signals via, the electric interface.

Optionally, the connecting of each of the adaptors includes connecting an adaptor which is configured to passively convert P2MP electric signals using a physical layer conversion in which the same media access control (MAC) layer data is transmitted over different physical layers between the respective P2MP communication line and the second part of the respective Pt2Pt communication line.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is a block diagram illustrating a topology of a prior art point-to-point communication system;

FIG. 2 is a block diagram illustrating a topology of a prior art point-to-multipoint communication system;

FIGS. 3A, 3B, 3C, 4, and 5 are block diagrams illustrating different implementations of a communication system, and of environments thereof, according to an embodiment of the invention;

FIGS. 6A through 6F exemplify various implementations of the communication is system, implemented in an exemplary building, according to an embodiment of the invention; and

FIG. 7 is a flow chart of a method for communication, according to an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF EMBODIMENTS

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

In the drawings and descriptions set forth, identical reference numerals indicate s those components that are common to different embodiments or configurations.

As used herein, the phrase “for example,” “such as”, “for instance” and variants thereof describe non-limiting embodiments of the presently disclosed subject matter. Reference in the specification to “one case”, “some cases”, “other cases” or variants thereof means that a particular feature, structure or characteristic described in connection with the embodiment(s) is included in at least one embodiment of the presently disclosed subject matter. Thus the appearance of the phrase “one case”, “some cases”, “other cases” or variants thereof does not necessarily refer to the same embodiment(s).

It is appreciated that certain features of the presently disclosed subject matter, Which are, for clarity, described in the context of separate embodiments, may also be is provided in combination in a single embodiment. Conversely, various features of the presently disclosed subject matter, which are, for brevity, described in the context of a single embodiment, may also be provided separately or in any suitable sub-combination.

In embodiments of the presently disclosed subject matter one or more stages illustrated in the figures may be executed in a different order and/or one or more groups of stages may be executed simultaneously and vice versa. The figures illustrate a general schematic of the system architecture in accordance with an embodiment of the presently disclosed subject matter. Each module in the figures can be made up of any combination of software, hardware and/or firmware that performs the functions as defined and explained herein. The modules in the figures may be centralized in one location or dispersed over more than one location.

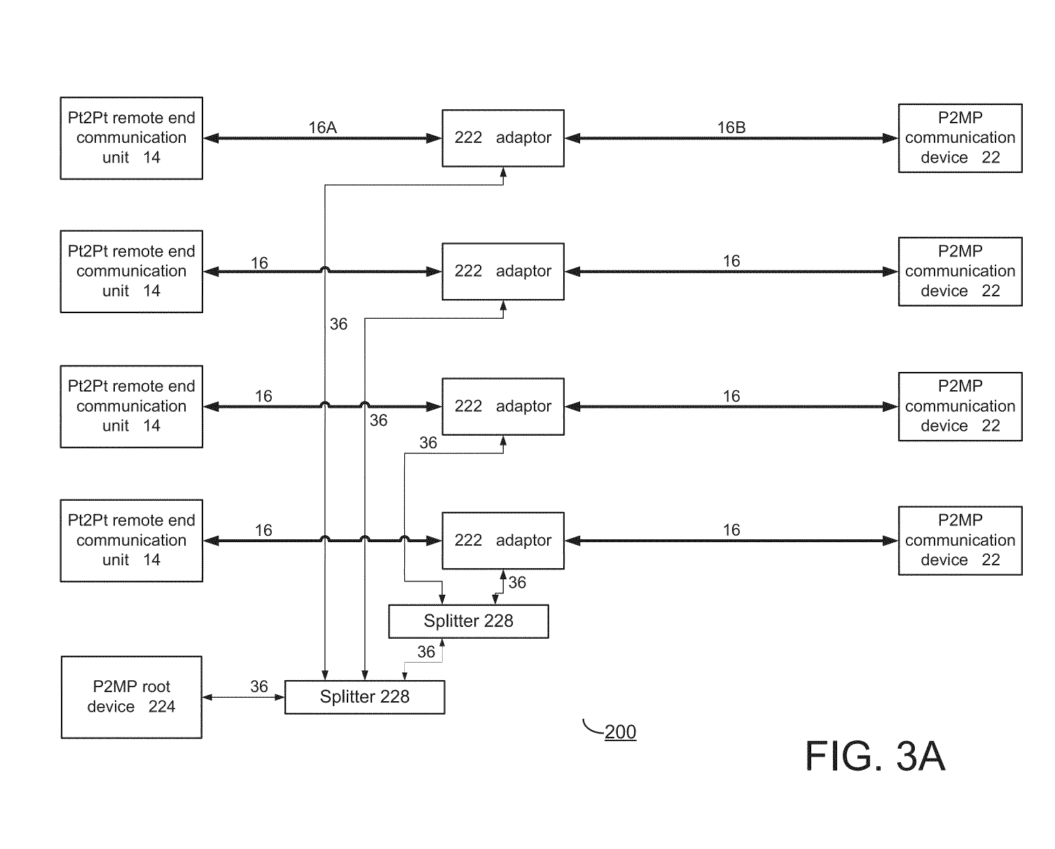

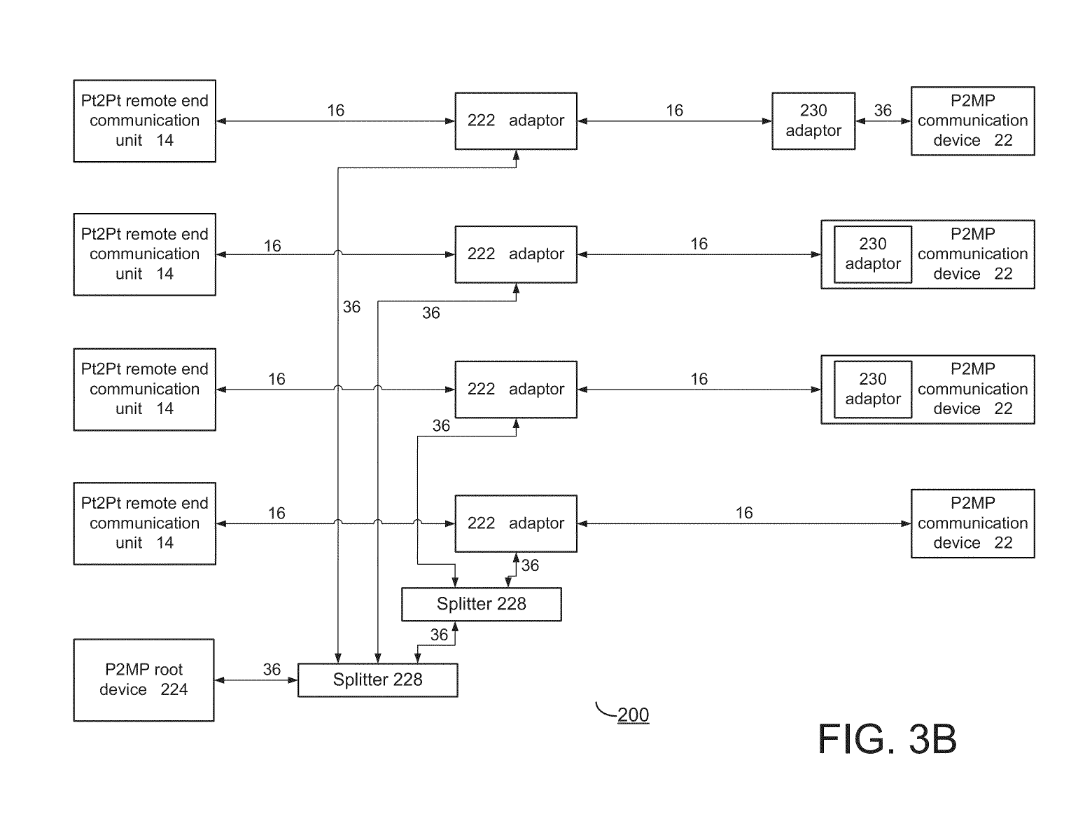

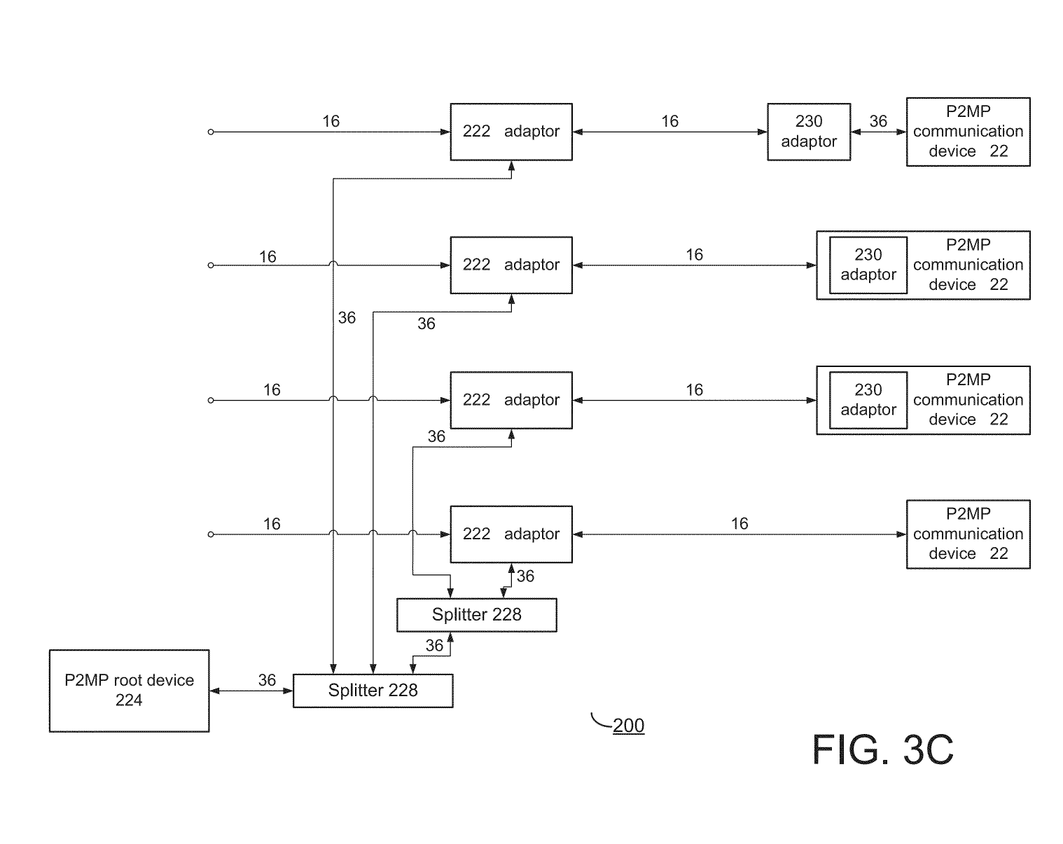

FIG. 3A is a block diagram illustrating communication system 200, according to an embodiment of the invention. System 200 includes multiple adaptors 222, each of which may be installed onto a wired communication line 16 of a point-to-point communication system (such as, though not limited to, prior art Pt2Pt communication system 10).

The wired communication lines 16, which belong to one or more point-to-point communication systems, may be pre-existing infrastructure which does not require dedicated installation. For example, an existing telephony interface may be previously installed in many buildings and/or building complexes. If this existing point-to-point infrastructure is not utilized to its full capacity (e.g. in aspects of bandwidth and/or time), additional communication may be transmitted on those lines 16, without disrupting point-to-point communication on those lines. Furthermore, in some situations utilizing those existing Pt2Pt communication lines 16 according to the teaching of the current invention may be more efficient when compared to existing Pt2Pt communication solutions.

At least one of the adaptors 222 (and possibly all of them) may include an electric interface to which preexisting operational Pt2Pt communication infrastructure which includes the respective Pt2Pt communication line is connected. The process of connecting the respective adaptor to this preexisting operational Pt2Pt communication infrastructure may be executed a long time after this communication infrastructure was installed (e.g. months, years, and even decades). In addition to such an electric interface, such an adaptor may also include a physical interface to which the respective Pt2Pt communication line may be connected (e.g. screws to secure it, etc.). The connecting of the adaptor to the preexisting communication lines may necessitate cutting the preexisting Pt2Pt communication line and connecting the different cut ends to different electric interfaces of the adaptor, but this is not necessarily so, and in other scenarios the adaptor may be connected to the preexisting communication line without cutting the latter.

It is however noted that the current invention does not depend on having Pt2Pt infrastructure previously installed on the site, and such infrastructure may also be installed, for example, as part of the implementation. Furthermore, the Pt2Pt communication lines 16 are not necessarily part of system 200. However, as also described herein, if preexisting Pt2Pt infrastructure is previously installed on a relevant site, it can be utilized according to the teachings of the present invention, as discussed below in greater detail.

Some or all of the Pt2Pt communication lines 16 may be connected on their remote end to multiple Pt2Pt remote end communication units 14, but this is not necessarily so. Those Pt2Pt remote end communication units 14 may be prior-art remote-end communication units (such as telephony remote end communication units 14), but may also be dedicated units. Pt2Pt remote end communication units 14 are not necessarily part of system 200, and may even not be implemented. For example, pre-existing telephony infrastructure does not necessarily have any telephony exchange or modems connected to it on the end opposite to the user-end.

It should be noted that the term user-end and user-end device is used as a matter of convenience. On top of the conventional meaning of this term in the art, the term “user end device” and its derivatives may be used for any communication device that may receive (and possibly also transmit) communication signals over a physical communication line connected thereto. While such a device may indeed be a termination point of a network, this is not necessarily so, and the term “user-end device” may also be a device that can connect to additional devices over other network connection. For example, the term “user-end device” may be used for intermediary devices such as splitters, routers, etc. It is noted that the term “user-end device” may be used also for devices that are not easily accessible to users, or which do not reside in the premises or vicinity of any specific user.

The term “user-end device” is known in the art and the additional definitions and explanations are provided for convenience purposes. Accordingly, the interpretation of the corresponding terms in the claims is, unless stated otherwise, not necessarily limited to these definitions, and that any term as used in the claims should be given its broadest reasonable interpretation.

If Pt2Pt remote end communication units 14 are indeed implemented, it is noted that multiple remote end communication units 14 may be implemented in a single device (e.g. a telephone exchange), wherein such a device includes different physical interface and PHY level connection to each of the respective wired connections 16. Such a single remote end device may be configured to communicate independently with each of the different user-end devices 12 so that the user-end devices 12 would not be exposed to the communication of any one of the other user-end devices 12.

In addition to being connected to the respective Pt2Pt communication line, each of the adaptors 222 is also connected to the P2MP root communication P2MP root communication device 224 by a respective P2MP communication line 36. This way, each of the adaptors 222 connects a single Pt2Pt communication line 16 to a point-to-multipoint root device 224, which may or may not be a part of system 200. P2MP root device 224 may be a prior art communication device (such as, for example, communication device 24 illustrated in FIG. 2), but this is not necessarily so. In but a few examples, root device 224 may be a MoCA (Multimedia over Coax Alliance) compliant communication device, a HPNA over Coax (HCNA) compliant communication device (wherein HPNA stands for HomePNA Alliance standard), and so forth.

It should be noted that communication device 224 is designed to operate over P2MP architecture, and not over Pt2Pt architecture. For example, since P2MP root device 224 may be configured to work in a treelike network configuration, wherein it resides in the root of the tree, it may only have a single physical interface and a single PHY level connection—much like prior art communication device 24.

It is noted that P2MP root device 224 may be configured to work in a star configuration in which it is connected to multiple P2MP communication lines, each of which is connected to a single P2MP user-end device 22. It is further noted that P2MP root device 224 may be configured to work in a hybrid star/tree configuration, in which it is connected to multiple P2MP communication lines, wherein at least some of these P2MP communication lines are connected to a tree-like sub-structure, having a P2MP user-end device 22 connected at its leaves. Wherever a treelike configuration is discussed, it is noted that other configurations (such as start configuration and hybrid configuration) may also be implemented, if applicable.

Therefore, one or more splitters 228 may be installed wherein P2MP root device 224 may connect to the adaptors 222 connecting it to each of the Pt2Pt communication lines 16 via splitter 228 (or multiple splitters 228 arranged serially, e.g., as illustrated). The lines connecting P2MP root device 224 to the splitter 228 and connecting the latter to the adaptors 222 (those lines denoted 36) may be of the similar kind to what would connect it in a pure P2MP configuration to the splitters 28 and user-end devices 22. For example, such cables may be coaxial cables (“Coax cables”). Furthermore, while not necessarily so, the one or more splitters 228 may be of similar kind to the splitters 28 that may be used in a pure P2MP configuration.

P2MP user-end devices 22 may be connected at the user-end end of some or all of the Pt2Pt communication lines 16. While not so illustrated, one or more of the illustrated P2MP user-end device 22 may be a splitter that connects multiple P2MP communication devices 22, and it may even connect to multiple Pt2Pt communication devices 12. For example, such a P2MP communication device splitter may be a wireless or a wired router.

As can be seen, P2MP root device 224 is connected to each of the P2MP user-end devices 22—possibly via one or more splitters 228, in a tree-like configuration. Each of the leaf nodes (at which the P2MP communication devices 22 of the illustration are connected) is connected to the P2MP root device 224 over a serial combination of a line 36 (used in P2MP communication) and a Pt2Pt communication line 16—which is of a different type. Since the lines 36 and 16 are of a different type, the adaptor 222 connecting those lines is configured to convert between different communication types.

In an example, if lines 36 are coax lines, while lines 16 are telephony communication lines, the adaptor 222 may include an electrical transformer that can convert electrical signals that are balanced about ground (e.g. telephony signals) to signals that are unbalanced (e.g. coax line signals), and vice versa. Some such electronic transformers are commonly referred to as BALUNs, a syllabic abbreviation blending balanced and unbalanced. Other types of adaptation may or may not be required, depending on the type of lines and on the type of communication transmitted in which.

Since adaptation of the communication is carried out away from P2MP root device 224, and since communication incoming to it is also adapted remotely, P2MP root device 224 may be a standard P2MP root device 24, without any modifications. In other implementations of the invention, such modifications may nevertheless be applied, in order to tailor an operation thereof to the combination of lines 36 and 16.

As P2MP user-end devices 22 may also be standard P2MP user-end devices (e.g. as shown in FIG. 2), those devices may not be able to connect directly to the respective Pt communication lines 16, and an adaptor 230 may be installed between the two. Such a configuration is implemented, for example, in FIG. 3B. Such an adaptor 230 may be installed as part of the respective P2MP user-end device 22, or externally to it.

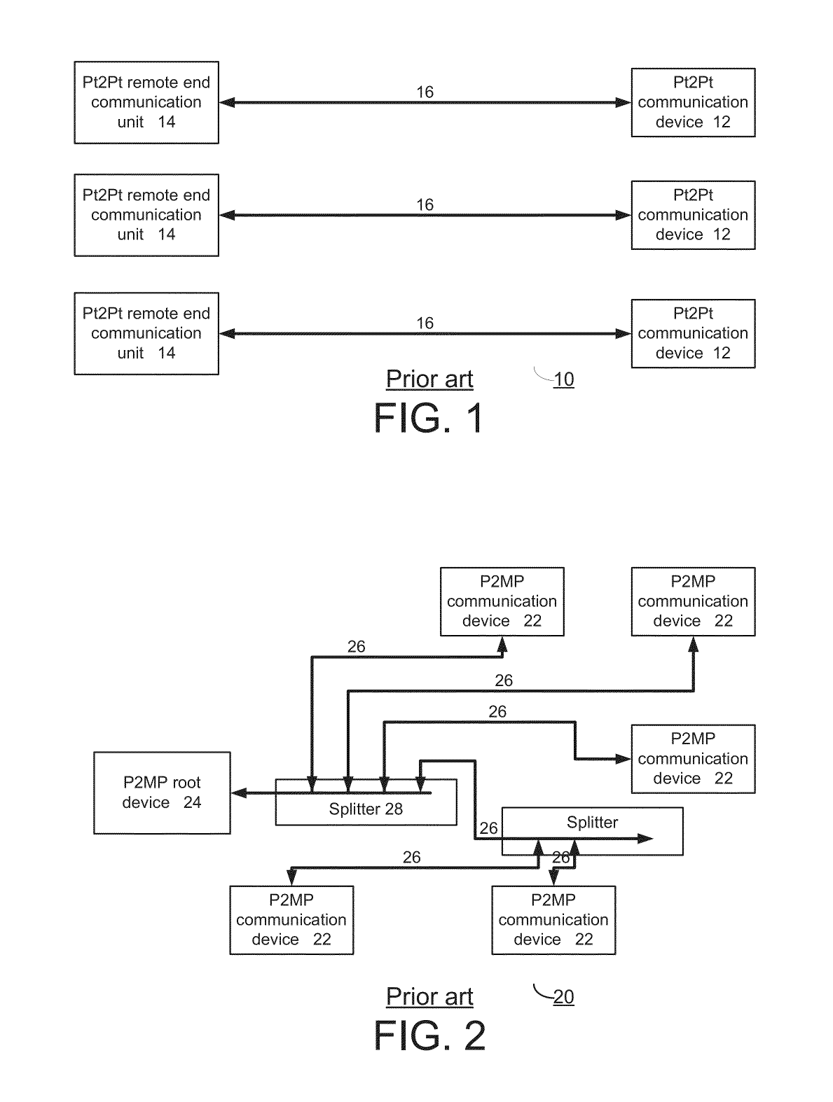

FIG. 3C illustrates system 200 as illustrated in FIG. 3B, but without the Pt2Pt remote end communication units 14 (which even if implemented do not necessarily constitute a part of system 200). For example, such an implementation may occur when utilizing pre-existing Pt2Pt infrastructure. Comparing the systems of FIGS. 1 and 3C, it can be seen that utilizing substantially the same infrastructure, a single P2MP root device 224 may serve many user-end units, when compared to the multiple Pt2Pt remote end communication units 14 of FIG. 1.

As was shown, the network configuration that includes P2MP root device 224, the multiple P2MP user-end communication P2MP user-end communication P2MP user-end devices 22 utilizes the adaptors 222 and the lines (and possibly other components) connecting between the nodes of the network to operate as a point-to-multipoint network. However, Pt2Pt communication lines 16 may also be used, in some implementations, for Pt2Pt communication, which is supposedly their original function.

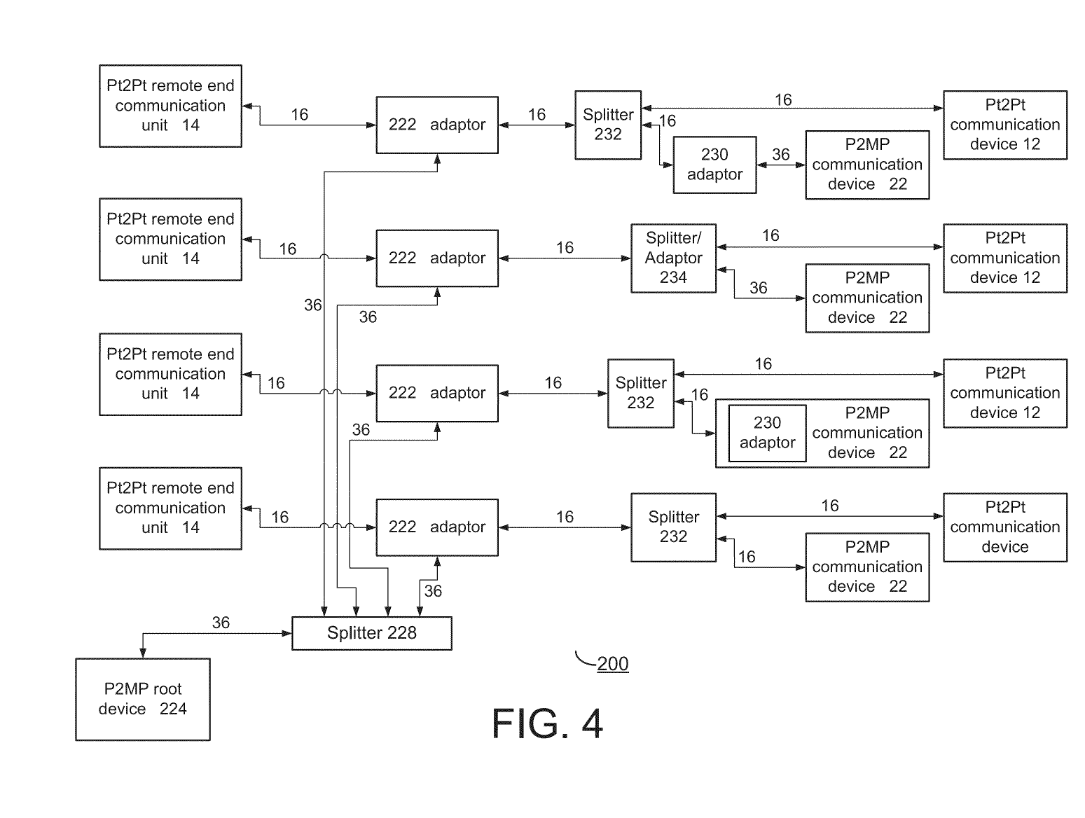

FIG. 4 is a block diagram illustrating communication system 200, according to an is embodiment of the invention. If lines 16 are also to be used for Pt2Pt communication between one or more Pt2Pt user-end devices 12 to one or more corresponding Pt2Pt remote end devices 14, a corresponding number of splitters 232 may be used. Each of those splitters 232 can split the communication arriving from the corresponding adaptor 222 towards the corresponding Pt2Pt communication device 12 and toward the corresponding P2MP communication device 22, and to transmit towards adaptor 222 communications arriving from either of those two devices.

When splitting the communication arriving from adaptor 222, the splitter 232 may also filter the communication, so only part of it reaches one of the devices 12 and 22. Possibly, such filtering includes transmitting only a part of the communication toward P2MP user-end device 22, and another part of it (mutually exclusive or not) towards Pt2Pt user-end device 12. Such a filter may be incorporated into the splitter 232, or may be external to it (implemented as one or two filters, each on the line leading to the corresponding user-end device). It is noted that a splitter 232 and an adaptor 230 may be combined into a single unit, denoted 234 in FIG. 4.

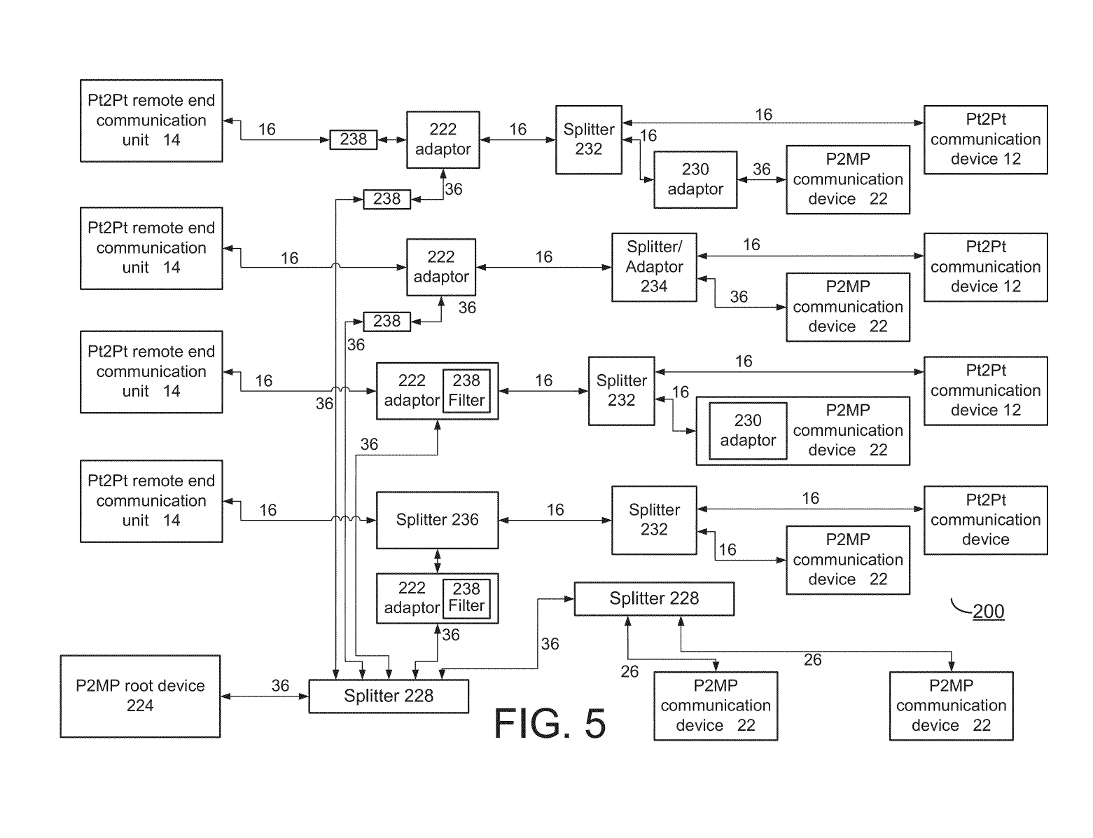

Filters may also be implemented on the connection points connecting P2MP root device 224 to each of the Pt2Pt communication lines 16. Such a filter 238, e.g. as illustrated in FIG. 5. is able to selectively transmit part of the communication passing through it. Such a filter 238 may be implemented as part of a respective adaptor 222, and may also be implemented as a standalone unit. For example, filter 238 may be used to prevent transmission of Pt2Pt communication from line 16 toward P2MP root device 224. Filter 238 may also be implemented to prevent transmission of P2MP communication toward a respective Pt2Pt remote end communication unit 14.

Naturally, filter 238 may also be implemented as a set of filters. For example, filter 238 may include one or more filters configured to filter out communication based on its signal frequency. Continuing the example in which Pt2Pt communication system is a telephony communication system and P2MP communication device 224 is a MoCA based remote end device, it is noted that in such an implementation these two communication systems operate in substantially different ranges of frequencies. Telephony frequencies are is relatively very low (measured in tens of Kilohertz and even less), while those of MoCA communication are hundreds of Megahertz and more. Therefore, a high-pass filter may prevent transmission of low frequency telephony communication transmissions towards P2MP root device 224, and/or a low-pass filter may be used to transmit only telephony communication towards Pt2PT remote end communication unit 14, and not high-speed data communication.

It should be noted that while adaptor 222 was described as converting the communication type from that suiting to lines 16 to that suiting lines 36 (and vice versa) as well as splitting the communication transmitted on line 16 also to a corresponding line 36, these two roles may be implemented by different components, e.g. as illustrated for the lowermost adaptor 222 of FIG. 5.

As also shown in FIG. 5 (which is a block diagram illustrating communication system 200, according to an embodiment of the invention), P2MP root device 224 may be connected to P2MP user-end devices also in a regular P2MP manner and over regular P2MP infrastructure. This is exemplified by the two lowermost P2MP communication devices, connected over P2MP infrastructure, with no conversion or adaptations to Pt2Pt communication infrastructure.

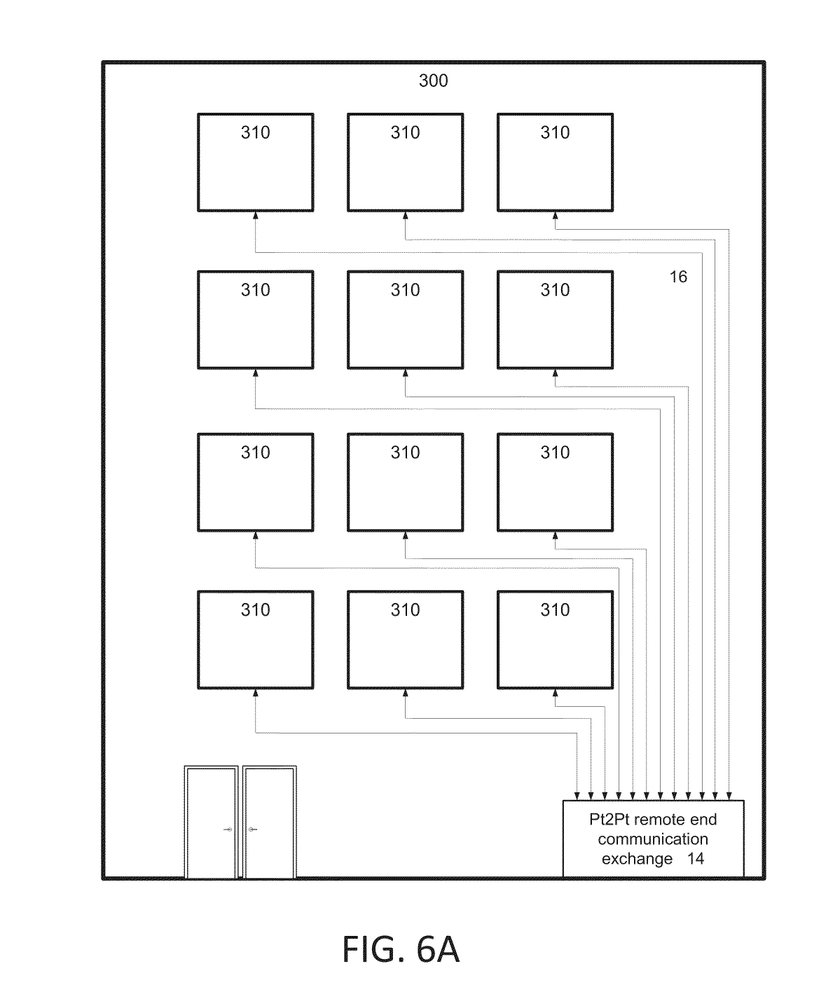

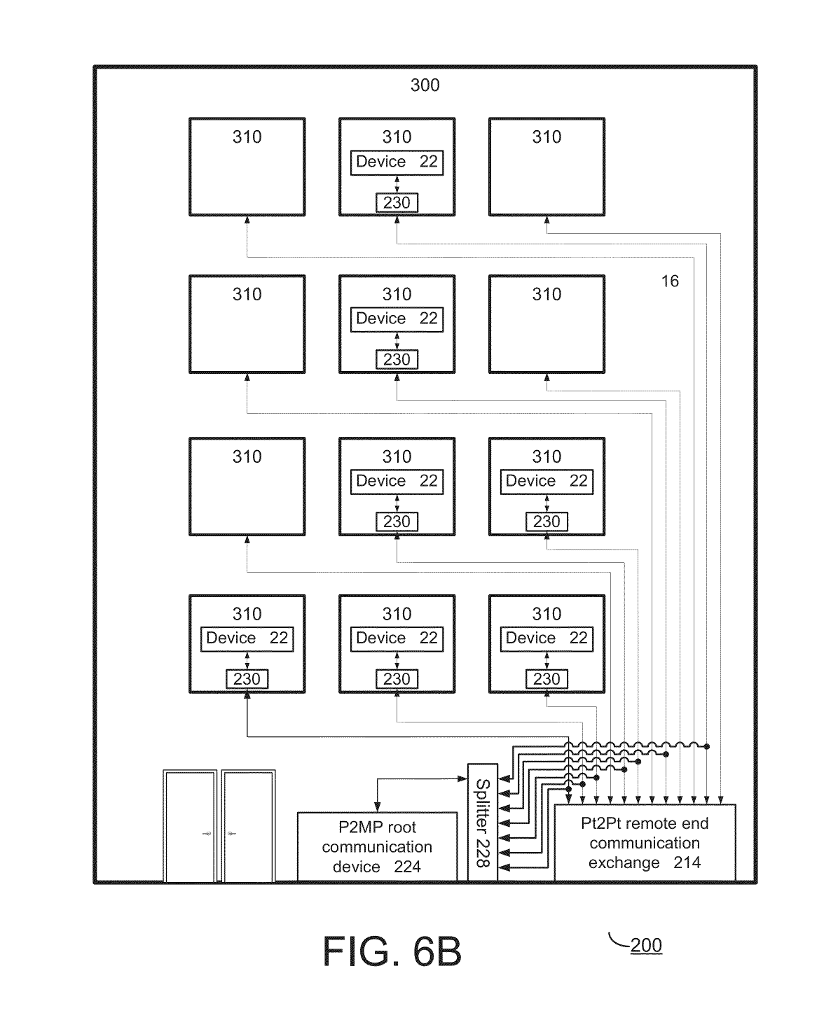

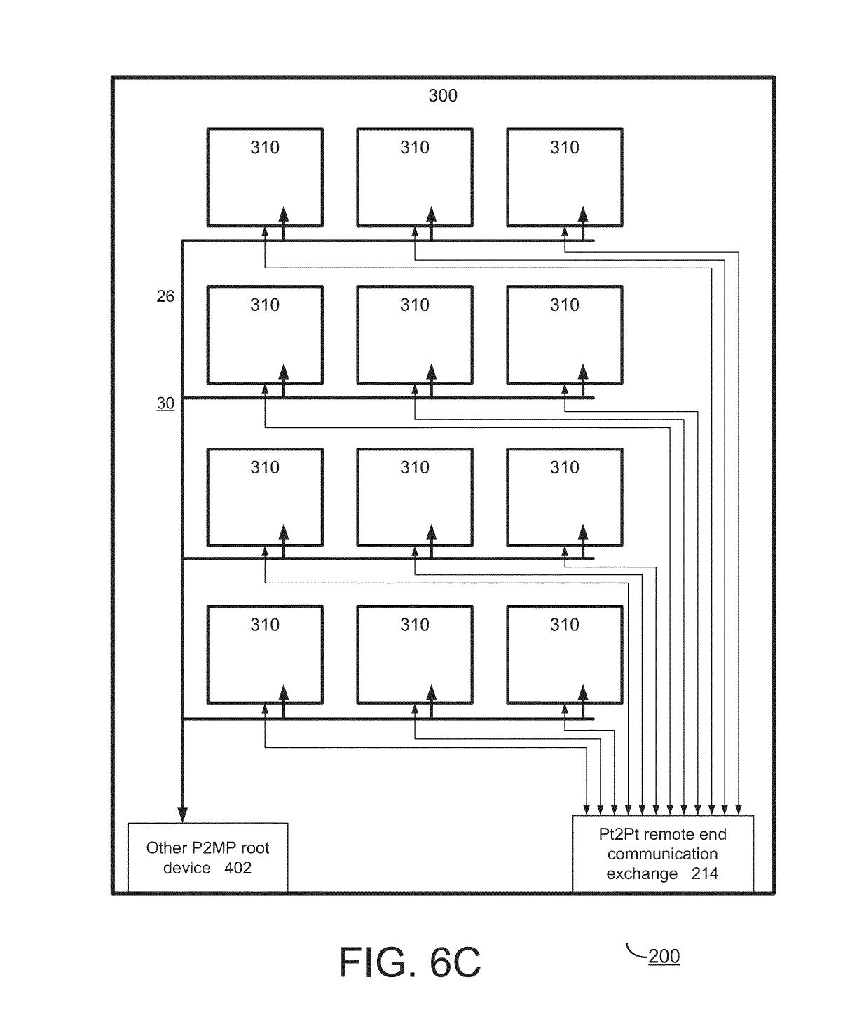

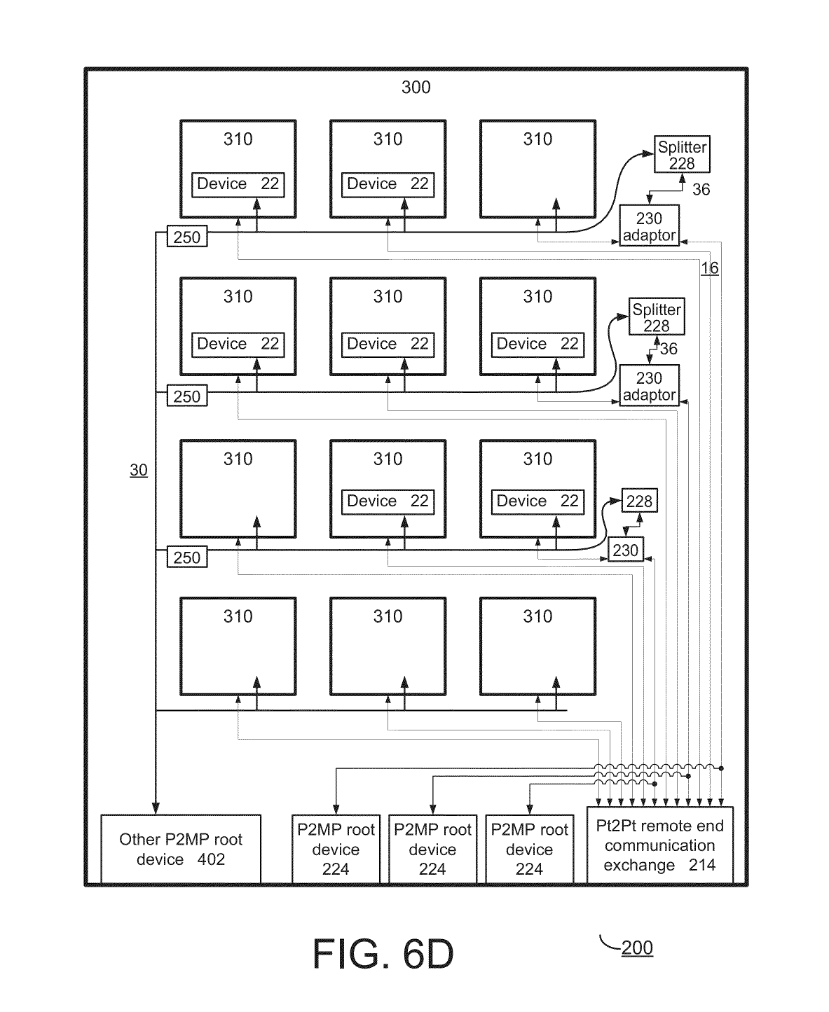

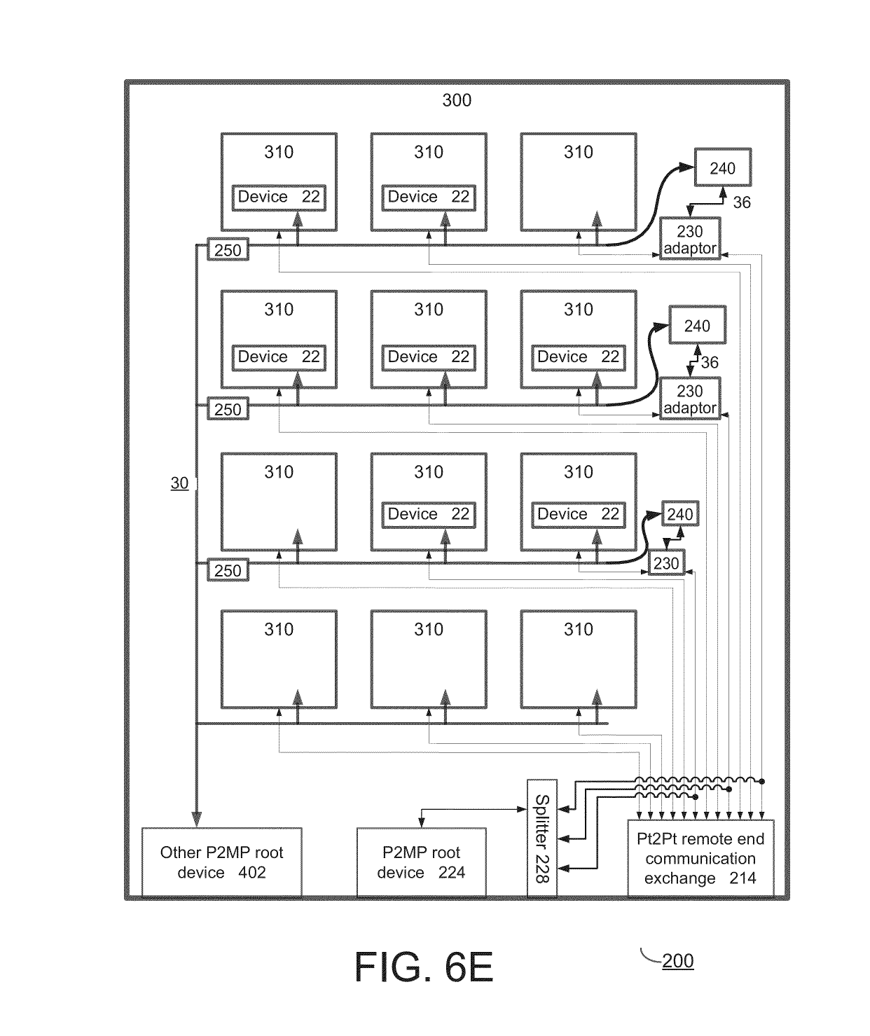

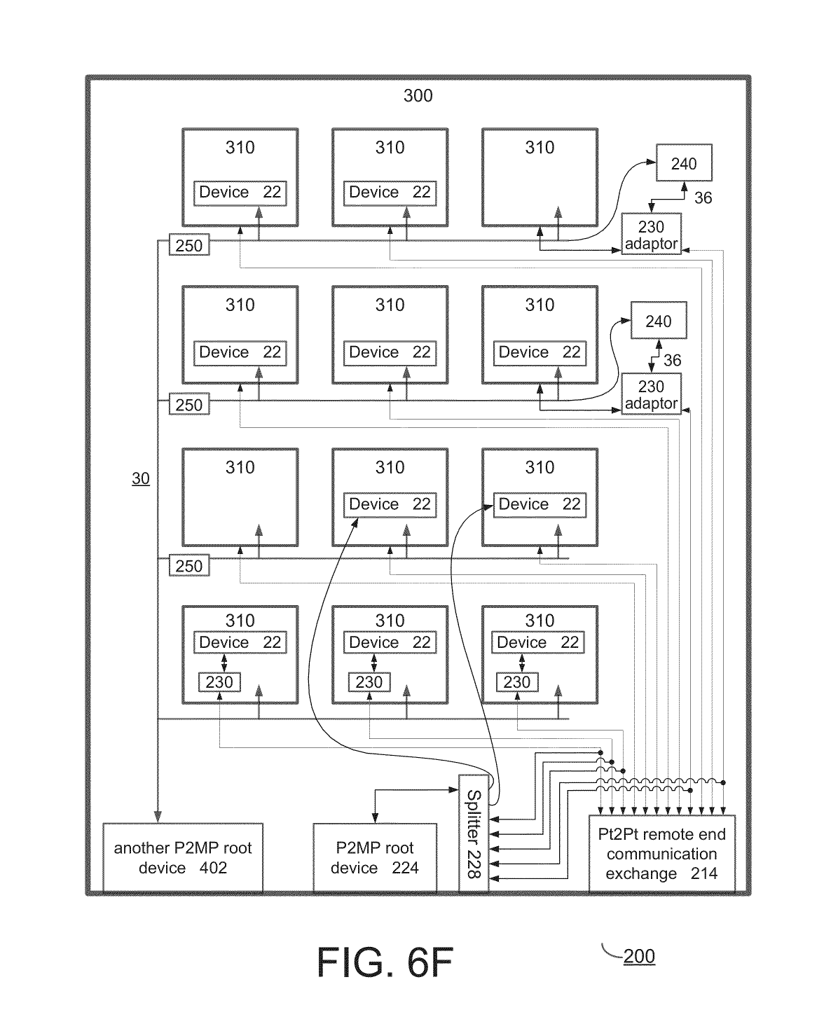

FIGS. 6A through 6F exemplify various implementations of system 200. In FIG. 6A a building 300 is illustrated, having multiple apartments 310 therein. It will be dear to a person who is of skill in the an that the implementations exemplified with relation to multiple apartments 310 in a multistory building may be extended to a wide range of other scenarios—e.g. multiple rooms in an apartment or on a floor, multiple apartments in several buildings or a neighborhood, multiple rooms in an office, hospital etc.

Continuing the same example, however, it is noted that each of the apartments 310 is connected with a Pt2Pt infrastructures such as Pt2Pt communication lines (e.g. telephony lines, twisted pair cables, etc.). The connection to each apartment is a standalone connection, which is not shared by any two apartments. It should be noted that such infrastructure is already installed in many existing buildings and neighborhoods, and will probably be installed in many buildings built in the future.

In the illustration, all of the Pt2Pt user-end devices 12 are connected to a single Pt2Pt remote end communication exchange 214 which as aforementioned may replace the multiple distinct Pt2Pt remote end devices 14. This assists in demonstrating that in some implementations, the multiple Pt2Pt communication lines 16 used may all pass within a physically confined space, and therefore may—in such an implementation—be accessed easily together. Such a confined space may be, for example, a single cable (or few cables substantially parallel to each other), a single communication cabinet (or few cabinets located near to each other, and possibly interconnected or controlled by a single entity), a room, a pipe, etc.

FIG. 6B further illustrates P2MP root device 224 that is connected via splitter 228 to a group including only some of the Pt2Pt communication lines 16, illustrating a scenario in which only some of the apartments 310 of the building are attached to P2MP remote end communication P2MP root device 224. For example, P2MP root device 224 may belong to a single Internet provisioning infrastructure supplier, to which some of the apartments 310 connect.

It is noted that while not illustrated—in a single building 300 (or neighborhood, etc.), more than one P2MP root device 224 may communicate with P2MP user-end devices 22 connected to it, in multiple networks. These networks may be mutually exclusive (in that each line 16 does not transfer communication of more than one P2MP user-end device 22), but this is not necessarily so In some implementations, more than one P2MP network may utilize a single Pt2Pt communication line 16. For example, the adaptors 222 (or other components) of each of the P2MP networks may be able to filter mutually exclusive ranges of frequencies, and so each P2MP network does not interfere with the other one or more P2MP networks (and possible Pt2Pt communication) transmitted in parallel on that communication line 16.

Returning to the example of FIG. 6B, the black circle illustrated on each of the communication lines 16 of the aforementioned group represents the adaptor 222 (and possibly also a filter 238 and/or a splitter 236, if implemented as separate components).

As can be seen, in the illustrated example—all of the Pt2Pt communication lines 16 pass in a very limited space in the vicinity of Pt2Pt communication exchange 214, and possibly also when no exchange is implemented, when a communication cabinet is implemented. It is noted that the multitude of Pt2Pt communication lines 16 may even belong to a single communication cable. For example, a commercially available telephony line of 100 pairs contains one hundred separate Pt2Pt communication lines 16.

It is noted that it may be relatively easy to connect all the adaptors 222 (and related components 236 and/or 238 if implemented) in that confined space (e.g. in the vicinity of the exchange 214 and/or of the communication cabinet). If installing system 200 in a location (e.g., a building) in which Pt2Pt infrastructure (and especially Pt2Pt communication lines 16) already exist, the installing may include cutting each of the required existing Pt2Pt communication lines 16, and connecting the two cut ends to two inputs of the installed adaptor 222 (and/or of the related components 236 and/or 238 if implemented).

If all the adaptors 222 (and/or such related components) are located within a confined space, a unit including multiple adaptors 222 may be implemented. Such a unit may be a “adaptors communication cabinet”, in which each adaptor includes at least an input for a P2MP communication line (e.g. for connecting to P2MP remote end communication P2MP root device 224), and two inputs for connecting to a Pt2Pt communication line (e.g. for connecting to the Pt2Pt communication line leading to a respective Pt2Pt user-end device 12, and for connecting to a Pt2Pt remote end communication unit 14 or exchange, if implemented).

Also, if all the adaptors 222 (and/or such related components) are located within a confined space, the P2MP root device 224 may be located in the same confined space or in the vicinity thereof. For example, the P2MP root device 224 may be located near the Pt2Pt remote end communication exchange 214.

It is also exemplified in FIG. 6B that the wired communication between P2MP root device 224 and each of the P2MP user-end devices 22 may mainly consist of Pt2Pt communication line 16, and only a relatively small portion of it may be P2MP communication line 36. For example, the length of a Pt2Pt communication line 16 leading to a P2MP user-end device 22 may easily exceed 100m, while the remaining length of the P2MP communication line 36 may be only few meters, and even less than a meter. Considering ratios, the ratio between the length of one of the P2MP communication lines 36 (measured between the P2MP root device 224 and the respective adaptor 222) to the length of the Pt2Pt communication line 16 to which it is connected (measured between that adaptor and the P2MP user-end device 22) can be 1:10, 1:20, 1:50, 1:100, 1:250, 1:1,000, and even smaller. It may also be larger, of course. That is, if a Pt2Pt communication infrastructure already exists in situ, then the additional length of communication lines that should be added may be relatively very small (especially when compared to installation of new independent P2MP communication infrastructure.

FIG. 6C illustrates the building 300 of FIG. 6A, only with P2MP infrastructure or another network also installed (possibly previously). This other P2MP network is denoted network 30. The exemplified infrastructure includes P2MP communication lines 26 leading to each of the apartments 310. Naturally, not all the apartments 310 are necessarily connected to that P2MP infrastructure, and some apartments may be connected to only one type of infrastructure (P2MP or P2MP), or to none of them. All the more so, some end points of each of these network infrastructures may not lead to apartments 310 at all, but rather may serve other utilities. The P2MP network illustrated in FIG. 6C may be, for example, a cable television (CATV) P2MP network. At the root node of this network, a P2MP root device 402 other than P2MP root device 224 may be installed (e.g. a CATV headend).

The number of user-end endpoints of the P2MP network illustrated in FIG. 6C is twelve, of which only three are located in each floor of the building 300. It is however understood that the number of such end-points may be much larger. For example, if the building 300 is a hospital or a hotel room, this number may very well reach hundreds and thousands of endpoints. While such a number of end-points may be handled by some P2MP networks (e.g. in CATV systems, Where all the end-points receive the same signal), in other P2MP networks, the root node may not be able to handle so many endpoints. For example, in some implementations of P2MP root device 224 in which it serves to communicate high bandwidth Internet connection, such an example device 224 may be able to handle a much smaller number of endpoints (e.g. several dozen).

FIG. 6D illustrates three P2MP networks, according to an embodiment of the invention. In this embodiment, each P2MP root device 224 is connected to a single Pt2Pt communication line 16, via an adaptor 222 (here also illustrated as a black circle). Along each of these lines 16, a splitter 228 is connected, so that P2MP root device 224 may communicate via the splitter 228. Another adaptor 230 (e.g. another BALUN adaptor) may be intermediately connected between the splitter 228 and the respective Pt2Pt communication line 16.

The splitter 228 is connected to the other P2MP network infrastructure, and so P2MP root device 224 can communicate with P2MP user-end devices 22 connected to the other P2MP network infrastructure 30. It is noted that the adaptor 230 may prevent transmission of Pt2Pt communication from the Pt2Pt communication lines 16 to the splitters 228.

If all of the P2MP root devices 224 are not designed so as to prevent interference with each other (e.g. if all of them utilize the same frequency range without coordinated frequency hopping schemes), then their communications over network 30 may interfere one with the other. Filters 250 may be implemented in different parts of P2MP network 30, so that different parts of it are isolated for use of P2MP networks managed by different P2MP root devices 224. However, these filters may still transmit P2MP communication of the other P2MP network 30. For example, CAW transmissions by the P2MP root device 402 may be received in all hotel rooms 310, while transmission by each of the different P2MP root devices 224 may be received only on a respective floor (if the dividing into groups or networks is by floors, as exemplified).

Here, all of the P2MP root devices 224 may be located next to each other, and there is no need to install a separate P2MP root device 402 in each of the floors. Also—this implementation may utilize not only existing Pt2Pt communication infrastructure, but also existing P2MP communication infrastructure, saving even further in the amount of new infrastructure to be laid.

Even if all infrastructures are to be laid together—still in the exemplified implementations, two types of communication infrastructure serve dual purposes—the Pt2Pt communication lines 16 serve both for Pt2Pt communication (e.g. telephony) and for P2MP communication (e.g. Internet connection), while the P2MP communication lines 26 serve for two types of P2MP communication managed by different P2MP root devices (e.g. CATV communication and data connection). It should be noted, that every communication line that serves two such purposes belongs to (at least) two networks, with different configurations and is topologies.

FIG. 6E illustrates another implementation utilizing network 30, this time with a single P2MP root device 224, which may be located in the vicinity of the Pt2Pt remote end communication exchange 214, or like position. In each of the sub-networks (e.g., in each of the floors) instead of a simple splitter 228, a device 240 that can manage communication of multiple P2MP user-end devices 22 may be implemented. Such a device 240 may have routing capabilities, multiplexing capabilities, and so forth (it may, for example, be a router, a multiplexer, a CMTS, etc.).

It will be clear to a person who is skilled in the art that many combinations of the exemplary topologies illustrated in the previous figures and discussed above may be made. By way of clarifying example illustration of how one such combination may look, FIG. 6F is provided. The P2MP root device 224 of FIG. 6F is connected to all of the P2MP user-end devices 22 in the building 300. It is connected to the three P2MP user-end devices 22 residing in the first floor in the same fashion as in the examples of FIGS. 3B and 3B; to the P2MP user-end devices 22 of the second floor directly using standard P2MP communication lines, and to the rest of the P2MP user-end devices 22 it connects in the same fashion as in the example of FIG. 6E.

Given all the combinations alternative, it should be noted that communication system 200 includes at least a point-to-multipoint (P2MP) root device (e.g. P2MP root P2MP root communication device 224) that is configured to communicate with multiple P2MP user-end devices (such as P2MP user-end communication devices 22) over a shared network accessible to each of the P2MP user-end devices, and one or more adaptors (such as adaptors 222). In some implementations, system 200 must include more than one adaptor (e.g. if each adaptor transfers information only to a single P2MP user-end device).

Each of the adaptors is connected between a first part (e.g. part 16A in FIG. 3A) and a second part (e.g. part 16B in FIG. 3A) of a respective Pt2Pt communication line, and also connected to the P2MP root communication device. The second part is the part leading towards a P2MP user-end device 22 (and possibly more), and the first part is the part continuing in the other direction. If Pt2Pt remote end communication unit 14 is connected to that Pt2Pt communication line 16, the first part of the line would lead to it.

Each of these adaptors is configured to: (a) transfer Pt2Pt electric signals of Pt2Pt communication between the first and the second parts of the respective Pt2Pt communication line; and (b) transfer. P2MP electric signals of P2MP communication between the second part of the respective Pt2Pt communication line and the respective P2MP communication line (which is used to connect the adaptor with the P2MP root communication device).

It is noted that the term “Pt2Pt electric signals” refers to the electric signals by which information is communicated between Pt2Pt communication devices. Likewise, the term “P2MP electric signals” refers to the electric signals by which information is communicated between P2MP communication devices. It is noted that the adaptor may also transfer additional electric signals between the respective communication devices to which it is connected (e.g. noise, electric signals of P2MP communication addressed to another P2MP communication device, etc.).

Each of the adaptors 222 is also configured to passively convert between the P2MP electric signals which are transferred over the respective P2MP communication line 36 and the P2MP electric signals of the transferred over the second part of the respective Pt2Pt communication line. Therefore, each of the adaptors may also be referred to as “passive adaptors”.

In such a passive conversion between the P2MP electric signals transferred over the respective P2MP communication line 36 and these transferred over the second part of the respective Pt2Pt communication line 16, the adaptor does not provide energy to the converted electric signals. It is noted that the adaptor may be configured to passively convert between such P2MP signals of communication going in both directions (e.g. from the P2MP root communication device 224 to the respective P2MP user-end communication device 22, and vice versa).

Some (or all) of the adaptors 222 in the system may be configured to passively convert the P2MP electric signals using a physical layer conversion, thereby transmitting the same media access control (MAC) layer data between the respective P2MP communication line and the second part of the respective Pt2Pt communication line over different physical layers.

The transferring of each of the types of communication may be a straight-forward transmission without any processing, but may also include some processing—e.g. modifying electronic signal by an electronic filter, changing frequencies thereof, etc. While in some embodiments the adaptor may be aware of the identity of the sender and/or the recipient of a transmission it transfers, this is not necessarily so and the adaptor may be unaware of any such identity.

The shared network over which the P2MP root device communicates with the multiple P2MP user-end devices (which is, as aforementioned, accessible to each of the P2MP user-end devices), may include the second part of each of the relevant P2MP communication lines, and the connection lines connecting the adaptors to the P2MP root device. The shared network may also include other components such as (though not limited to): splitters (e.g. splitters 228, 232, 236), additional adaptors connected between the second parts of the Pt2Pt communication lines and the P2MP user-end devices (e.g. adaptors 230, 234), filters (e.g. filters 238 filters in splitters 232 or in adaptors 230), P2MP communication management device (e.g. devices 240), P2MP communication lines (e.g. connected between second parts of the Pt2Pt communication lines and the P2MP use-end devices). etc.

The shared network is accessible to each of the P2MP user-end devices in that each of the P2MP user-end devices receives all the information transmitted in the shared network. Ideally, all of the P2MP user-end devices receive the same information, but naturally some variations may occur (e.g. the amplitude of the received signal may vary between different P2MP user-end devices). It is noted necessarily that all (or even any) of the P2MP user-end devices are permitted or able to transmit in the shared network (some of them may be passive devices), but if one or more of the devices (possibly all of them) do transmit data in the network, this transmission is likewise accessible to each of the P2MP user-end devices.

All of the P2MP communication transmitted in the shared network (which, as aforementioned, includes the second parts of all of the Pt2Pt communication lines) may be transmitted to each of the P2MP user-end devices.

One or more (possibly all) of the adaptors 222 may be further configured to block transmission of P2MP communication to the first part of the respective Pt2Pt communication line, which may be used to prevent transmission of P2MP communication towards the Pt2Pt remote end communication unit 14, if present. This blocking is optional for various reasons, e.g. such Pt2Pt remote end communication unit may not be implemented, and, even if implemented, its functioning is not necessarily affected by the P2MP communication (e.g. it may be of different frequency range which does not interfere with the Pt2Pt equipment down the first part of the Pt2Pt communication line).

One or more (possibly all) of the adaptors 222 may be further configured to block transmission of Pt2Pt communication to the P2MP root device. This blocking is optional for various reasons, e.g. the functioning of the P2MP root device is not necessarily affected by he Pt2Pt communication (e.g. it may be of different frequency range which does not interfere with the P2MP equipment).

The P2MP user-end devices may be or may be not part of communication system 200. Communication system 200 may include multiple P2MP user-end devices as well as the Pt2Pt communication lines connecting each of the adaptors to a different P2MP user-end device. As aforementioned, such so called “user-end” devices are not necessarily termination-points of the P2MP network, and some of which may be, for example, splitters, or other devices. Such devices may be connected to one or more additional P2MP communication devices.

Considering the example of FIG. 6D, for example, the P2MP user-end device to which the P2MP root device 224 transmits communications is splitter 228 (which may and may not be combined with adaptor 230), wherein that user-end device transfers P2MP communication towards additional P2MP communication devices—e.g. the illustrated devices 22. If indeed a termination point, the “user-end devices” may be, for example, a modem, a personal computer, a CATV set-top-box (STB), remotely controlled equipment, and so forth.

Some parts of the shared network (and especially some or all of the second parts) may be concurrently used for transmission of P2MP communication and for transmission of Pt2Pt communication. At least one of the adaptors (and optionally all of them) may be configured to concurrently transfer P2MP communication and Pt2Pt communication over the respective second part of the Pt2Pt communication line, wherein the P2MP communication is Ws transferred to the respective P2MP user-end device (e.g. a device 22), and the Pt2Pt communication is transmitted to a respective Pt2Pt user-end communication device (e.g. a device 14) that is separate from the respective P2MP user-end device (and which is connected to the same Pt2Pt communication line).

Reverting to the length ratio between the two types of communication lines, according to an embodiment of the invention, a ratio between (a) a length of any P2MP communication line connection the P2MP root device 224 and (b) a respective adaptor to a length of the second part of the respective Pt2Pt communication line that connects the adaptor to the respective P2MP user-end device is smaller than 1:50. In other variations it may be smaller than any of the other values indicated above, e.g. 1:100, 1:1,000.

As discussed above (e.g. with relation to FIG. 6F), at least one of the P2MP user-end devices may be an intermediary device (such as, for example, device 240) that is configured to transmit over at least a part of another P2MP network P2MP (e.g. network 30) communication received from the P2MP root device, wherein P2MP communication of a different P2MP root device (e.g. device 402) is transmitted in the other P2MP network. In such an implementation, system 200 may include at least one filter (e.g. filter 250) that prevents transmission of P2MP communication transmitted by the intermediary device to a part of the other P2MP network.

Referring to FIG. 6D, each P2MP root device may also be connected to a single adaptor (such as adaptor 230). As aforementioned, in FIG. 6D such an adaptor (denoted in previous drawings as 222) is illustrated by a black circle. In FIG. 6D, three P2MP root devices 224 are illustrated, each of which is connected to a single such adaptor. Any one of these three communication systems includes at least:

a point-to-multipoint (P2MP) root device 224, configured to communicate with multiple P2MP user-end devices 22 over a shared network accessible to each of the P2MP user-end devices 22 (such network including at least the respective Pt2Pt communication line 16, the adaptor 222, and at least part of the P2MP communication lines of the other P2MP network 30);

an adaptor 222 connected between a first part and a second part of a Pt2Pt communication line 16, and also connected to the P2MP root communication device 224 by a respective P2MP communication line; the adaptor 222 is configured to: (i) transfer Pt2Pt electric signals of Pt2Pt communication between the first and the second parts of the respective Pt2Pt communication line 16; (ii) transfer P2MP electric signals of P2MP communication between the second part of the respective Pt2Pt communication line 16 and the respective P2MP communication line (c) passively convert between the P2MP electric signals which are transferred over the respective P2MP communication line and the P2MP electric signals of the P2MP communication transferred over the second part of the respective Pt2Pt communication line; and

an intermediary device 240 configured to transmit P2MP communication received from the P2MP root device 224 over at least a part of another P2MP network 30 in which P2MP communication of a different P2MP root device is transmitted.

It is noted that in system 200, not all of the available Pt2Pt communication lines 16 are necessarily used.

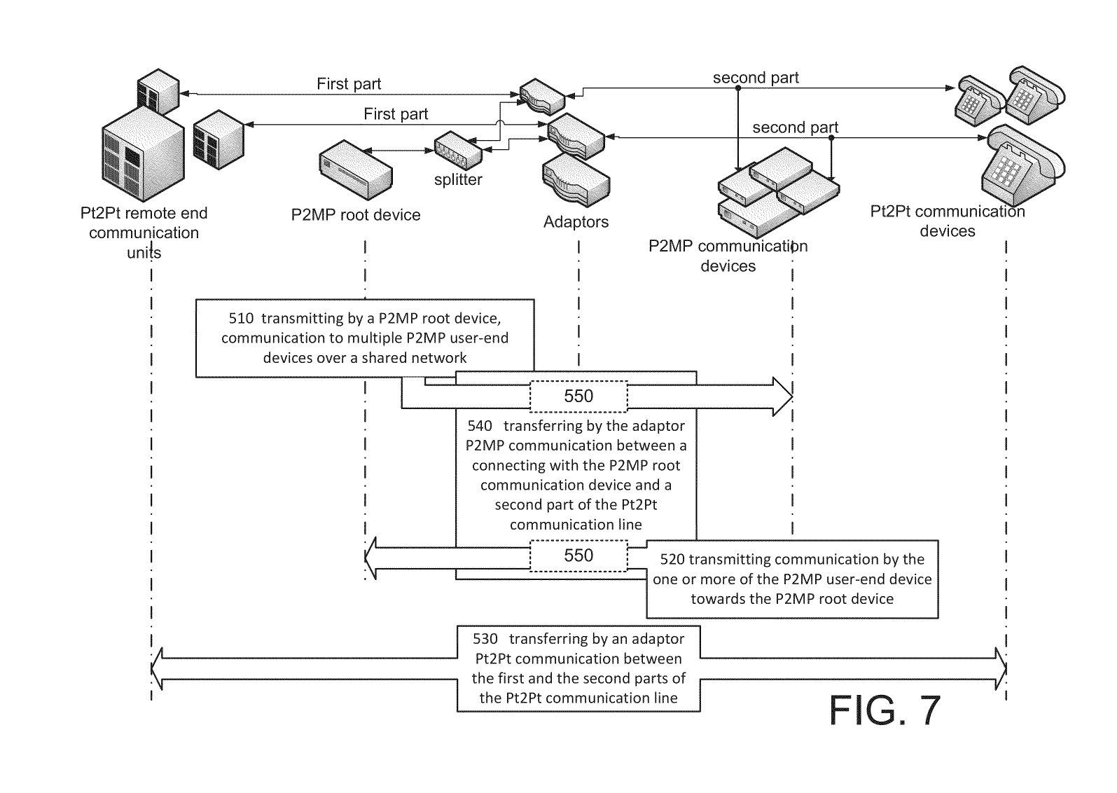

FIG. 7 is a flow chart of method 500 for communication, according to an embodiment of the invention. Especially, method 500 may be used for P2MP communication. Referring to the examples set forth in the previous drawings, it is noted that method 500 may be carried out by communication system 200 (wherein different stages of method 500 may be carried out by different components of communication system 200, if applicable). It will be clear to a person who is of skill in the art that the various implementations of system 200 may be incorporated to various implementations of method 500, even if not explicitly elaborated.

Method 500 includes stage 510 of transmitting, by a point-to-multipoint (P2MP) root device, P2MP electric signals of P2MP communication to multiple P2MP user-end devices over a shared network accessible to each of the P2MP user-end devices. Referring to the examples set forth in the previous drawings, stage 510 may be carried out by a P2MP root device such as P2MP root device 224. The P2MP user-end devices may be P2MP user-end devices 22. The shared network may be the shared network as discussed above.

Method 500 may include receiving by the P2MP root device electric signals of P2MP communication from one or more of the multiple P2MP user-end devices over the shared network, Such receiving may include receiving the P2MP communication transmitted in stage 520 by the one or more of the P2MP user-end devices towards the P2MP root device. Stage 520 may be carried out at least partly concurrently with stage 510, but this is not necessarily so. Method 500 may include stage 520 of transmitting communication by the one or more of the P2MP user-end devices towards the P2MP root device.

Stage 530 of method 500 includes transferring, by an adaptor that is connected between a first part and a second part of a Pt2Pt communication line and also connected to the P2MP root communication device by a respective P2MP communication line, Pt2Pt electric signals of Pt2Pt communication between the first and the second parts of the Pt2Pt communication line. Referring to the examples set forth in the previous drawings, stage 520 may be carried out by an adaptor such as adaptor 222, and the respective Pt2Pt communication line may be one of the Pt2Pt communication lines 16.

Stage 540 of method 500 includes transferring by the adaptor P2MP electric signals of P2MP communication between the respective P2MP communication line and the second part of the Pt2Pt communication line.

Stage 540 includes stage 550 of passively converting between the P2MP electric signals which are transferred over the respective P2MP communication line and the P2MP electric signals of the P2MP communication transferred over the second part of the respective Pt2Pt communication line.

During the passive conversion of stage 550 between the P2MP electric signals transferred over the respective P2MP communication line and these transferred over the second part of the respective Pt2Pt communication line, no energy is provided by the adaptor to the converted electric signals. It is noted that the passive conversion of the electric signals in stage 550 may include passively converting between such P2MP signals of communication going in both directions (e.g. from the P2MP root communication device to the respective P2MP user-end communication device, and vice versa).

Optionally, the passive converting of the P2MP electric signals in stage 550 may include passively converting the P2MP electric signals using a physical layer conversion, thereby transmitting the same media access control (MAC) layer data between the respective P2MP communication line and the second part of the respective Pt2Pt communication line over different physical layers.

Method 500 may further include transferring, by each adaptor of a group of one or more other adaptors wherein each of the other adaptors is connected to the P2MP root device and between a first part and a second part of a respective other Pt2Pt communication line, Pt2Pt communication between the first and the second parts of the respective other Pt2Pt communication line; and transferring by each other adaptor P2MP communication between a connecting of the other adaptor with the P2MP root communication device and a second part of the respective other Pt2Pt communication line. Referring to the examples set forth in the previous drawings, the transmission by the other adaptors may be carried out by other adaptors 222.

Method 500 may include: for at least one other adaptor which is connected to the P2MP root device by a respective other P2MP communication line and between a first part and a second part of a respective other Pt2Pt communication line, transferring by the other adaptor Pt2Pt electric signals of Pt2Pt communication between the first and the second parts of the respective other Pt2Pt communication line; and transferring by the other adaptor P2MP electric signals of P2MP communication between the respective other P2MP communication line and the second part of the respective other Pt2Pt communication line; wherein the transferring of the P2MP electric signals by the other adaptor comprises passively converting between the P2MP electric signals which are transferred over the respective other P2MP communication line and the P2MP electric signals of the P2MP communication transferred over the second part of the respective other Pt2Pt communication line.

Method 500 may include blocking by the adaptor transmission of P2MP communication to the first pan of the respective Pt2Pt communication line, and/or blocking by the adaptor transmission of Pt2Pt communication to the P2MP root device.

It is noted that possibly, the transferring of the P2MP communication may be carried out at least partly concurrently with the transferring of the Pt2Pt communication, wherein the P2MP communication is transferred to a respective P2MP user-end device, and the Pt2Pt communication is transmitted to a respective Pt2Pt user-end communication device that is separate from the respective P2MP user-end device.

Method 500 may also include transmitting over at least a part of another P2MP network P2MP, by one of the P2MP user-end devices which is an intermediary device, communication received from the P2MP root device, wherein P2MP communication of a different P2MP root device is transmitted in the other P2MP network. Referring to the examples set forth in the previous drawings, this stage may be carried out by a communication device such as device 240. Method 500 may also include preventing transmission of P2MP communication transmitted by the intermediary device to a part of the other P2MP network.

It is noted that method 500 may be used as part of a method for utilizing preexisting operational Pt2Pt communication infrastructure for P2MP communication (herein after referred to as “the upgraded communication method”). The upgraded communication method includes:

For each out of multiple Pt2Pt communication lines of the preexisting operational Pt2Pt communication infrastructure, connecting to the respective Pt2Pt communication line an adaptor (e.g. a passive adaptor in the sense discussed above);

Providing a P2MP root device and connecting the P2MP root device to all of the adaptors, the connecting comprising connecting the P2MP root device to each of the adaptors by a P2MP communication line; and

Communicating over the preexisting operational Pt2Pt communication infrastructure Pt2Pt communication and P2MP communication, according to method 500.

It is noted that the order in which the different components of the new communication system generated may vary (e.g. first connecting the adaptors to the Pt2Pt lines and then to the P2MP root communication device, or the other way round).

The upgraded communication method may also include locating the preexisting operational Pt2Pt communication infrastructure which does not include any P2MP infrastructure and which is not connected to any P2MP communication device, and only then connecting the adaptors to the aforementioned Pt2Pt communication lines.

It is noted that the connecting of each of the adaptors to the respective Pt2Pt communication line may include connecting the respective P communication line to an electric interface of the respective adaptor. In such a case, the transferring of the P2MP electric signals by the adaptor includes transferring the P2MP electric signals via the electric interface.

The connecting of each of the adaptors may include connecting an adaptor which is configured to passively convert P2MP electric signals using a physical layer conversion in which the same media access control (MAC) layer data is transmitted over different physical layers between the respective P2MP communication line and the second part of the respective Pt2Pt communication line.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

It will be appreciated that the embodiments described above are cited by way of example, and various features thereof and combinations of these features can be varied and modified.

While various embodiments have been shown and described, it will be understood that there is no intent to limit the invention by such disclosure, but rather, it is intended to cover all modifications and alternate constructions fabling within the scope of the invention, as defined in the appended claims.

What is claimed is:

1. A communication system, the system comprising:
a point-to-multipoint (P2MP) root device, configured to communicate with multiple P2MP user-end devices over a shared network accessible to each of the P2MP user-end devices; and
multiple adaptors, each of which is coupled between a first part and a second part of a respective point to point (Pt2Pt) communication line, and also coupled to the P2MP root communication device by a respective P2MP communication line;
wherein each of the adaptors is configured to:
transfer Pt2Pt electric signals of Pt2Pt communication between first and the second parts of the respective Pt2Pt communication line;
transfer P2MP electric signals of P2MP communication between the second part of the respective Pt2Pt communication line and the respective P2MP communication line; and
passively convert between the P2MP electric signals which are transferred over the respective P2MP communication line and the P2MP electric signals of the P2MP communication transferred over the second part of the respective Pt2Pt communication line.

2. The system according to claim 1, wherein each of the multiple adaptors is configured to passively convert the P2MP electric signals using a physical layer conversion, thereby transmitting the same media access control (MAC) layer data between the respective P2MP communication line and the second part of the respective Pt2Pt communication line over different physical layers.

3. The system according to claim 1, wherein at least one of the adaptors includes an electric interface to which preexisting operational Pt2Pt communication infrastructure which includes the respective Pt2Pt communication line is coupled.

4. The system according to claim 1, wherein at least one of the adaptors is further configured to block transmission of P2MP communication to the first part of the respective Pt2Pt communication line.

5. The system according to claim 1, wherein at least one of the adaptors is further configured to block transmission of Pt2Pt communication to the P2MP root device.

6. The system according to claim 1, further comprising the multiple P2MP user-end devices and the Pt2Pt communication lines coupling each of the adaptors to a different P2MP user-end device.

7. The system according to claim 1, wherein all of the P2MP communication transmitted in the shared network, which comprises the second parts of all of the Pt2Pt communication lines, is transmitted to each of the P2MP user-end devices.

8. The system according to claim 1, wherein at least one of the adaptors is configured to concurrently transfer P2MP communication and Pt2Pt communication over the respective second part of the Pt2Pt communication line, wherein the P2MP communication is transferred to the respective P2MP user-end device, and the Pt2Pt communication is transmitted to a respective Pt2Pt user-end communication device that is separate from the respective P2MP user-end device.

9. The system according to claim 1, wherein a ratio between (a) a length of any P2MP communication line coupling the P2MP root device 224 and (b) a respective adaptor to a length of the second part of the respective Pt2Pt communication line that couples the adaptor to the respective P2MP user-end device is smaller than 1:50.

10. The system according to claim 1, wherein at least one of the P2MP user-end devices is an intermediary device configured to transmit over at least a part of another P2MP network P2MP communication received from the P2MP root device, wherein P2MP communication of a different P2MP root device is transmitted in the other P2MP network.

11. The system according to claim 10, further comprising at least one filter that prevents transmission of P2MP communication transmitted by the intermediary device to apart of the other P2MP network.

12. A communication system, the system comprising:
a point-to-multipoint (P2MP) root device, configured to communicate with multiple P2MP user-end devices over a shared network accessible to each of the P2MP user-end devices;
an adaptor coupled between a first part and a second part of a Pt2Pt communication line, and also coupled to the P2MP root communication device by a respective P2MP communication line; the adaptor is configured to: transfer Pt2Pt electric signals of Pt2Pt con between the first and the second parts of the respective Pt2Pt communication line; and transfer P2MP electric signals of P2MP communication between the second part of the respective Pt2Pt communication line and the respective P2MP communication line; and to passively convert between the P2MP electric signals which are transferred over the respective P2MP communication line and the P2MP electric signals of the P2MP communication transferred over the second part of the respective Pt2Pt communication line; and
an intermediary device configured to transmit P2MP communication received from the P2MP root device over at least a part of another P2MP network in which P2MP communication of a different P2MP root device is transmitted.

13. The system according to claim 12, wherein the adaptor is configured to passively convert the P2MP electric signals using a physical layer conversion, thereby transmitting the same media access control (MAC) layer data between the respective P2MP communication line and the second part of the respective Pt2Pt communication line over different physical layers.

14. A method for communication, the method comprising:
transmitting by a point-to-multipoint (P2MP) root device P2MP communication to multiple P2MP user-end devices over a shared network accessible to each of the P2MP user-end devices;
transferring, by an adaptor that is coupled between a first part and a second part of a Pt2Pt communication line and also coupled to the P2MP root communication device by a respective P2MP communication line, Pt2Pt electric signals of Pt2Pt communication between the first and the second parts of the Pt2Pt communication line; and
transferring by the adaptor P2MP electric signals of P2MP communication between the respective P2MP communication line and the second part of the Pt2Pt communication line, the transferring of the P2MP electric signals comprising passively converting between the P2MP electric signals which are transferred over the respective P2MP communication line and the P2MP electric signals of the P2MP communication transferred over the second part of the respective Pt2Pt communication line.

15. The method according to claim 14, wherein the passive converting of the P2MP electric signals comprises passively converting the P2MP electric signals using a physical layer conversion, thereby transmitting the same media access control (MAC) layer data between the respective P2MP communication line and the second part of the respective Pt2Pt communication line over different physical layers.

16. The method according to claim 14, further comprising: for at least one other adaptor which is coupled to the P2MP root device by a respective other P2MP communication line and between a first part and a second part of a respective other Pt2Pt communication line, transferring by the other adaptor Pt2Pt electric signals of Pt2Pt communication between the first and the second parts of the respective other Pt2Pt communication line; and transferring by the other adaptor P2MP electric signals of P2MP communication between the respective other P2MP communication line and the second part of the respective other Pt2Pt communication line; wherein the transferring of the P2MP electric signals by the other adaptor comprises passively converting between the P2MP electric signals which are transferred over the respective other P2MP communication line and the P2MP electric signals of the P2MP communication transferred over the second part of the respective other Pt2Pt communication line.

17. A method for utilizing preexisting operational Pt2Pt communication infrastructure for P2MP communication, the method comprising:
for each out of multiple Pt2Pt communication lines of the preexisting operational Pt2Pt communication infrastructure, coupling to the respective Pt2Pt communication line an adaptor;
providing a P2MP root device and coupling the P2MP root device to all of the adaptors, the coupling comprising coupling the P2MP root device to each of the adaptors by a P2MP communication line; and
communicating over the preexisting operational Pt2Pt communication to infrastructure Pt2Pt communication and P2MP communication, according to the method of claim 14.

18. The method according to claim 17, wherein the coupling of the adaptors is preceded by locating the preexisting operational Pt2Pt communication infrastructure which does not include any P2MP infrastructure and which is not coupled to any P2MP communication device.

19. The method according to claim 17, wherein the coupling of each of the adaptors comprises coupling the respective Pt2Pt communication line to an electric interface of the respective adaptor, wherein the transferring of the P2MP electric signals by the adaptor comprises transferring the P2MP electric signals via the electric interface.

20. The method according to claim 17, wherein the coupling of each of the adaptors comprises coupling an adaptor which is configured to passively convert P2MP electric signals using a physical layer conversion in which the same media access control (MAC) layer data is transmitted over different physical layers between the respective P2MP communication line and the second part of the respective Pt2Pt communication line.
